(19) United States
(12) Patent Application Publication
(10) Pub. No.: US 2016/0379402 A1
(43) Pub. Date: Dec. 29, 2016

(54) Apparatus and Method for Rendering a Source Pixel Mesh Image

(71) Applicant: Northrop Grumman Systems Corporation, Falls Church, VA (US)

(72) Inventors: Jon Mayfield, Orange, CA (US); Adrian Kaehler, North Hollywood, CA (US)

(21) Appl. No.: 14/750,404

(22) Filed: Jun. 25, 2015

(51) Int. Cl. G06T 15/04; G06T 15/80; G06T 15/10

(52) U.S. Cl. CPC G06T 15/04; G06T 15/10; G06T 15/80; G06T 2200/04; G06T 2207/10032

(57) ABSTRACT

A method for rendering a source pixel mesh image is provided including receiving a source image comprising a plurality of source pixels, defining a connector line between at least two source pixels, interpolating a color value of the connector line, and causing the source pixel mesh image comprising the at least two source pixels and the connector line to be rendered on a display.

### TECHNICAL FIELD

Example embodiments generally relate to image rendering and, in particular, relate to rendering a source pixel mesh image.

### BACKGROUND

Geographic Information Systems (GIS) often overlay data from multiple data sources in a spatially indexed manner. Content corresponding to a particular geographic location, such as a pixel within satellite image representing a particular geographic feature or a polyline vertex corresponding to a position along a vector representation of a roadway, may be aligned and overlayed within a display of a particular geographic region. Most systems allow the user to change the spatial extent of the displayed geographic region by “zooming in” to greater magnification levels or “zooming out” to lesser magnification levels of the content. Following an inward zoom, a smaller portion of the entire content available must be rendered across the extent of the display (e.g. a desktop window).

Because it is mathematically defined, vector content (e.g. lines, shapes, letters, and symbols) can be rendered with a high degree of precision even at very high magnification levels. In contrast, the spatial resolution (i.e. the number of pixels per unit of geographic length) of raster imagery is fixed at the time of acquisition. Consequently, at increasingly higher magnifications, fewer and fewer pixels within the source imagery must span the extent of the display, resulting in increasingly visible pixelization effects. These artifacts are particularly distracting when the low resolution imagery layer is displayed in a stack of layers containing vector content that is not beset by similar artifacts. Upsampling using interpolation techniques can provide some aesthetic relief to these undesirable effects, but of course does not create any new information. Moreover, upsampling may actually mislead the user, implying a degree of data fidelity (e.g. higher spatial frequency content) that does not actually exist within the source.

### BRIEF SUMMARY OF SOME EXAMPLES

Accordingly, some example embodiments may enable rendering of a source pixel mesh image as described below. In one example embodiment, an apparatus for rendering a source pixel mesh image is provided. The apparatus includes processing circuitry configured to execute instructions which when executed cause performance of operations including receiving a source image comprising a plurality of source pixels, defining a connector line between at least two source pixels; interpolating a color value of the connector line, and rendering the source pixel mesh image comprising the at least two source pixels and the connector line.

In another embodiment a method is provided for rendering a source pixel mesh image including receiving a source image comprising a plurality of source pixels, defining a connector line between at least two source pixels, interpolating a color value of the connector line, and rendering the source pixel mesh image comprising the at least two source pixels and the connector line.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a functional block diagram of a system that may be useful in connection with rendering a source pixel mesh image according to an example embodiment;

FIG. 2 illustrates a functional block diagram of an apparatus that may be useful in connection with rendering a source pixel mesh image according to an example embodiment;

FIG. 3 illustrates a source image rendered at a low magnification and a high magnification in accordance with an example embodiment;

FIGS. 4A-D illustrate example embodiments of source pixel mesh image configurations in accordance with some example embodiments;

FIG. 4E illustrates an example overlay of a source pixel mesh image on a second image in accordance with an example embodiment;

FIG. 5 illustrates a three dimensional rendering of a source pixel mesh image in accordance with an example embodiment;

FIG. 6 illustrates an example source pixel mesh image at a high level of magnification in accordance with an example embodiment; and

FIG. 7 illustrates a method of rendering a source pixel mesh image in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

In some examples, the present invention may provide an apparatus and method for rendering relatively low special resolution imagery at high magnifications and free of distracting or misleading artifacts. At magnification levels which may result in unacceptable pixilation or undesirable upsampling, e.g. a magnification in which the number of display pixels in the area in which the source image is displayed exceeds the number of pixels in the source image or portion of the source image displayed, each source pixel may be represented by a circle with lines connected the adjacent circles.

The color of each source pixel circles match the color, e.g. red/green/blue (RGB) values, of each corresponding source pixel. The connector lines, may have a color which varies along the length of the line to smoothly transition between the color values of the source pixel circles at either end of the connector line.

The rendered image, e.g. the source pixel mesh image, may be free of pixelization artifacts. Additionally, because the source pixel mesh image does not create upsampled pixels that are visually indistinguishable from the source pixels, the source pixel mesh image may not invite the user to infer a level of fidelity which is not present in the source image data.

In an instance in which the user desires to rely on interpolated data, the source pixel mesh image may provide interpolated data in the form of the connector lines. By presenting the interpolated data and source pixel circles in a visually distinguishable manner, the user may be alerted that they may desire to treat the interpolated data with caution, and that the source pixel circles clearly show the center point and color values of the source pixels.

In an instance in which multiple images are overlaid, such as a GIS, the sparse nature of the source pixel mesh image may allow a convenient viewing of the content of an underlying image or images without altering the visibility, e.g. via visibility toggling or alpha channel adjustment, of the low resolution layer. The source pixel mesh image connection lines may allow for visual coherency even at high levels of magnification.

### Example System

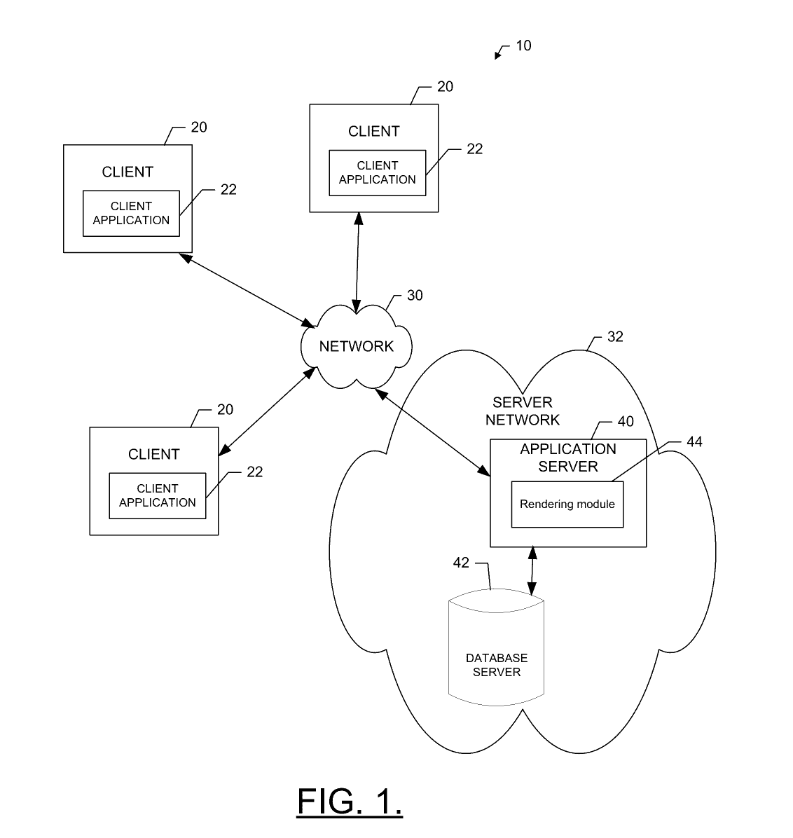

An example embodiment of the invention will now be described in reference to FIG. 1, which illustrates an example system in which an embodiment of the present invention may be employed. As shown in FIG. 1, a system 10 according to an example embodiment may include one or more client devices (e.g. clients 20). Notably, although FIG. 1 illustrates three clients 20, it should be appreciated that a single client or many more clients 20 may be included in some embodiments and thus, the three clients 20 of FIG. 1 are simply used to illustrate a potential for a multiplicity of clients 20 and the number of clients 20 is in no way limiting to other example embodiments. In this regard, example embodiments are scalable to inclusion of any number of clients 20 being tied into the system 10. Furthermore, in some cases, some embodiments may be practiced on a single client without any connection to the system 10.

The example described herein will be related to an asset comprising a computer or analysis terminal to illustrate one example embodiment. However, it should be appreciated that example embodiments may also apply to any asset including, for example, any programmable device that is capable of receiving and analyzing files or image data, as described herein.

The clients 20 may, in some cases, each be associated with a single organization, department within an organization, or location (i.e., with each one of the clients 20 being associated with an individual analyst of an organization, department or location). However, in some embodiments, each of the clients 20 may be associated with different corresponding locations, departments or organizations. For example, among the clients 20, one client may be associated with a first facility of a first organization and one or more of the other clients may be associated with a second facility of either the first organization or of another organization.

Each one of the clients 20 may include or otherwise be embodied as computing device (e.g. a computer, a network access terminal, a personal digital assistant (PDA), cellular phone, smart phone, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients 20 as described below. In an example embodiment, one or more of the clients 20 may include a client application 22 configured to operate in accordance with an example embodiment of the present invention. In this regard, for example, the client application 22 may include software for enabling a respective one of the clients 20 to communicate with the network 30 for requesting and/or receiving information and/or services via the network 30. Moreover, in some embodiments, the information or services that are requested via the network may be provided in a software as a service (SAS) environment. The information or services receivable at the client applications 22 may include deliverable components (e.g. downloadable software to configure the clients 20, or information for consumption/processing at the clients 20). As such, for example, the client application 22 may include corresponding executable instructions for configuring the client 20 to provide corresponding functionalities for rendering a source pixel mesh image, as described in greater detail below.

The network 30 may be a data network, such as a local area network (LAN), a metropolitan area network (MAN), a wide area network (WAN) (e.g. the Internet), and/or the like, which may couple the clients 20 to devices such as processing elements (e.g. personal computers, server computers or the like) and/or databases. Communication between the network 30, the clients 20 and the devices or databases (e.g. servers) to which the clients 20 are coupled may be accomplished by either wireline or wireless communication mechanisms and corresponding communication protocols.

In an example embodiment, devices to which the clients 20 may be coupled via the network 30 may include one or more application servers (e.g. application server 40), and/or a database server 42, which together may form respective elements of a server network 32. Although the application server 40 and the database server 42 are each referred to as “servers,” this does not necessarily imply that they are embodied on separate servers or devices. As such, for example, a single server or device may include both entities and the database server 42 could merely be represented by a database or group of databases physically located on the same server or device as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an example embodiment, one function that may be provided by the application server 40 may be the provision of access to information and/or services related to operation of the terminals or computers with which the clients 20 are associated. For example, the application server 40 may be configured to provide for storage of information descriptive of images (e.g. binary codes associated with digital images, such as landscape images, portrait images, satellite images, areal images, and/or the like). In some cases, these contents may be stored in the database server 42. Alternatively or additionally, the application server 40 may be configured to provide analytical tools for use by the clients 20 in accordance with example embodiments.

In some embodiments, for example, the application server 40 may therefore include an instance of a rendering module 44 comprising stored instructions for handling activities associated with practicing example embodiments as described herein. As such, in some embodiments, the clients 20 may access the rendering module 44 online and utilize the services provided thereby. However, it should be appreciated that in other embodiments, the rendering module 44 may be provided from the application server 40 (e.g. via download over the network 30) to one or more of the clients 20 to enable recipient clients to instantiate an instance of the rendering module 44 for local operation. As yet another example, the rendering module 44 may be instantiated at one or more of the clients 20 responsive to downloading instructions from a removable or transferable memory device carrying instructions for instantiating the rendering module 44 at the corresponding one or more of the clients 20. In such an example, the network 30 may, for example, be a peer-to-peer (P2P) network where one of the clients 20 includes an instance of the rendering module 44 to enable the corresponding one of the clients 20 to act as a server to other clients 20. In a further example embodiment, the rendering module 44 may be distributed amongst one or more clients 20 and/or the application server 40.

In an example embodiment, the application server 40 may include or have access to memory (e.g. internal memory or the database server 42) for storing instructions or applications for the performance of various functions and a corresponding processor for executing stored instructions or applications. For example, the memory may store an instance of the rendering module 44 configured to operate in accordance with an example embodiment of the present invention. In this regard, for example, the rendering module 44 may include software for enabling the application server 40 to communicate with the network 30 and/or the clients 20 for the provision and/or receipt of information associated with performing activities as described herein. Moreover, in some embodiments, the application server 40 may include or otherwise be in communication with an access terminal (e.g. a computer including a user interface) via which analysts may interact with, configure or otherwise maintain the system 10.

As such, the environment of FIG. 1 illustrates an example in which provision of content and information associated with the rendering such as, for example, security or intelligence operations may be accomplished by a particular entity (namely the rendering module 44 residing at the application server 40). However, it should be noted again that the rendering module 44 could alternatively handle provision of content and information within a single organization. Thus, in some embodiments, the rendering module 44 may be embodied at one or more of the clients 20 and, in such an example, the rendering module 44 may be configured to handle provision of content and information associated with analytical tasks that are associated only with the corresponding single organization. Access to the rendering module 44 may therefore be secured as appropriate for the organization involved and credentials of individuals or analysts attempting to utilize the tools provided herein.

### Example Apparatus

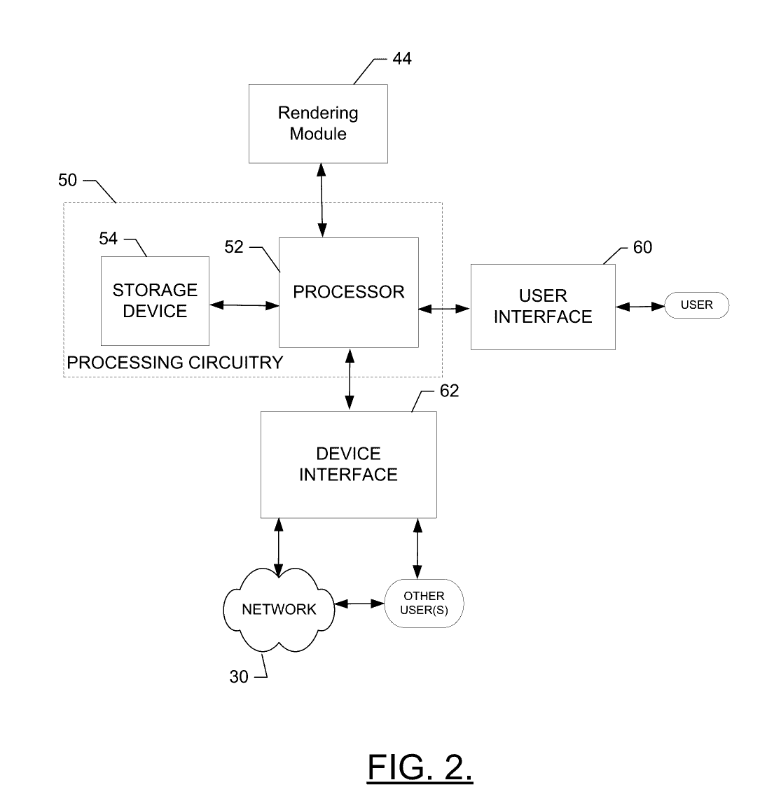

An example embodiment of the invention will now be described with reference to FIG. 2. FIG. 2 shows certain elements of an apparatus for rendering a source pixel mesh image according to an example embodiment. The apparatus of FIG. 2 may be employed, for example, on a client (e.g. any of the clients 20 of FIG. 1) or a variety of other devices (such as, for example, a network device, server, proxy, or the like (e.g. the application server 40 of FIG. 1)). Alternatively, embodiments may be employed on a combination of devices. Accordingly, some embodiments of the present invention may be embodied wholly at a single device (e.g. the application server 40 or one or more clients 20) or by devices in a client/server relationship (e.g. the application server 40 and one or more clients 20). Furthermore, it should be noted that the devices or elements described below may not be mandatory and thus some may be omitted in certain embodiments.

Referring now to FIG. 2, an apparatus rendering a source pixel mesh image is provided. The apparatus may be an embodiment of the rendering module 44 or a device hosting the rendering module 44. As such, configuration of the apparatus as described herein may transform the apparatus into the rendering module 44. In an example embodiment, the apparatus may include or otherwise be in communication with processing circuitry 50 that is configured to perform data processing, application execution and other processing and management services according to an example embodiment of the present invention. In one embodiment, the processing circuitry 50 may include a storage device 54 and a processor 52 that may be in communication with or otherwise control a user interface 60 and a device interface 62. As such, the processing circuitry 50 may be embodied as a circuit chip (e.g. an integrated circuit chip) configured (e.g. with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g. at a computer terminal or client device such as one of the clients 20) that may be in communication with the processing circuitry 50 via the device interface 62 and/or a network (e.g. network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms. In embodiments where the apparatus is embodied at a server or other network entity, the user interface 60 may be limited or even eliminated in some cases. Alternatively, as indicated above, the user interface 60 may be remotely located.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 54 may include one or more non-transitory storage or memory devices such as, for example, volatile and/or non-volatile memory that may be either fixed or removable. The storage device 54 may be configured to store information, data, applications, instructions or the like for enabling the apparatus to carry out various functions in accordance with example embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g. database server 42) that may store a variety of files, contents or data sets. Among the contents of the storage device 54, applications (e.g. client application 22 or service application 42) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g. physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an example embodiment, the processor 52 (or the processing circuitry 50) may be embodied as, include or otherwise control the rendering module 44, which may be any means, such as, a device or circuitry operating in accordance with software or otherwise embodied in hardware or a combination of hardware and software (e.g. processor 52 operating under software control, the processor 52 embodied as an ASIC or FPGA specifically configured to perform the operations described herein, or a combination thereof) thereby configuring the device or circuitry to perform the corresponding functions of the rendering module 44 as described below.

The rendering module 44 manager may include tools to facilitate the creation and rendering of a source pixel mesh image via the network 30. In an example embodiment the rendering module 44 may be configured to receive a source image including a plurality of source pixels from a memory, such as memory device 52 or database server 42. The rendering module 44 may be configured to define a connector line between at least two source pixels and interpolate a color value of the connector line. The rendering module 44 may be configured to cause the source pixel mesh image to be rendered on a display, such as user interface 60. In some example embodiments, the rendering module may be configured to receive a second image corresponding to the source image, e.g. sharing an attribute, such as in a spatial coordinate system, such geographic coordinates in GIS, and overlay the source pixel mesh image on the second image. The second image may be visible through the source pixel mesh image when rendered.

In some embodiments, the rendering module 44 may further include one or more components or modules that may be individually configured to perform one or more of the individual tasks or functions generally attributable to the rendering module 44. However, the rendering module 44 need not necessarily be modular. In cases where the rendering module 44 employs modules, the modules may, for example, be configured to render a source pixel mesh image as described herein, compare sequences and/or the like. In some embodiments, the rendering module 44 and/or any modules comprising the rendering module 44 may be any means such as a device or circuitry operating in accordance with software or otherwise embodied in hardware or a combination of hardware and software (e.g. processor 52 operating under software control, the processor 52 embodied as an ASIC or FPGA specifically configured to perform the operations described herein, or a combination thereof) thereby configuring the device or circuitry to perform the corresponding functions of the rendering module 44 and/or any modules thereof, as described herein.

### Example Renderings of Source Images at Various Magnification Levels

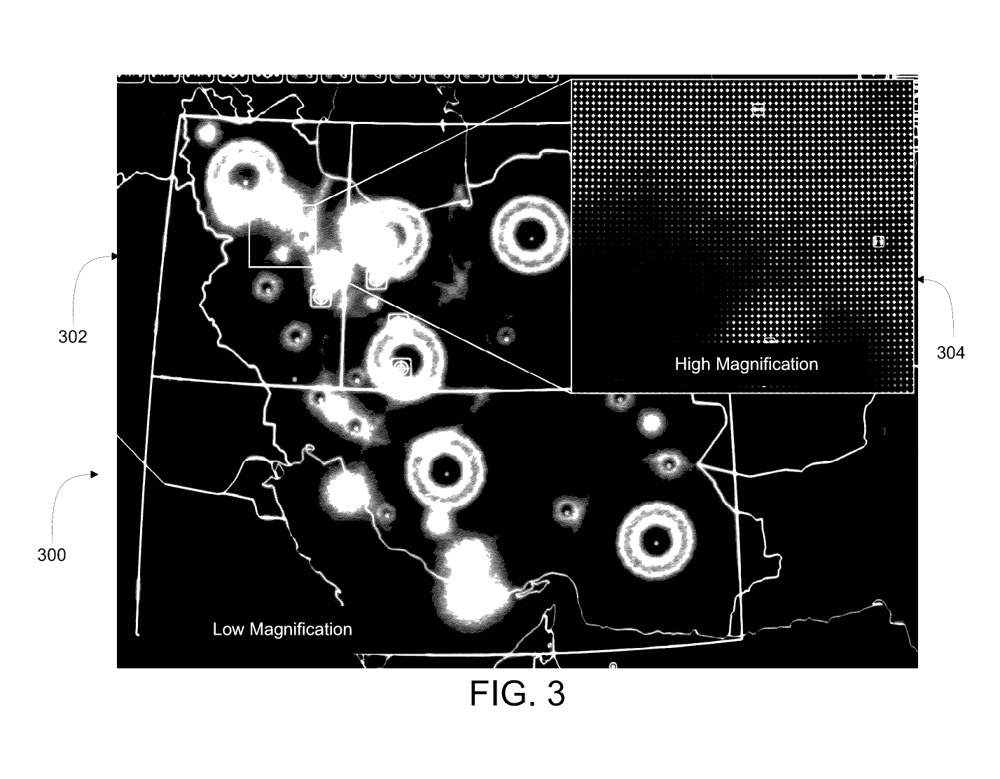

An example embodiment will now be described in general terms in relation to the rendering of a source pixel image. At low levels of magnification of the source image 300, such as the source image 302 of FIG. 3, each display pixel may correspond to more than one source pixel. The multiple source pixels corresponding to each display pixel may be downsampled (e.g. averaged) to obtain a color value for the display pixel. The color value may be a set of RGB values, greyscale value, or other color model values.

At a “neutral” magnification level, each of the display pixels may directly correspond to a source pixel at a one to one ratio. The color value of each display pixel may be equal the color value of the source pixel.

At a moderately high magnification level, each of the source pixels may correspond to a display pixel array of m×m display pixels, for example a 2×2 or 4×4 array of display pixels. The color value of each of the m×m display pixels may be directly replicated from the corresponding source pixel color value. Alternatively, the color value of each display pixel may be interpolated between the color values of the source pixel and the adjacent and/or diagonal source pixels, e.g. a bicubic interpolation of the source pixels, or other interpolation. “Adjacent,” as used herein relative to pixels, shall be interpreted as pixels which have an edge which touches the source pixel, such as 4-connected pixels. “Diagonal,” as used herein relative to pixels, shall be interpreted to mean pixels which have a corner touching the source pixel, such as 8-connected pixels.

At high magnification levels, each of the source pixels may correspond to a display pixel array of n×n display pixels, e.g. n=5, 10, or the like, at which the interpolation technique discussed above may yield undesirable pixelization. A source pixel mesh image may be generated and rendered, such as the source pixel mesh image 304, of FIG. 3, which is a high magnification of source image 302. In an example embodiment, each source pixel may be rendered as a cluster of display pixels, e.g. a 2×2 array of display pixels, a single display pixel, or the like, with connector lines between each of the adjacent source pixel renderings. The cluster of display pixels may have a characteristic dimension, such as a radius or side length. In some example embodiments, the source pixel may be rendered as a circle, with a radius of n/2 display pixels, n/4 display pixels, n/8 display pixels, or the like. The rendered circle may be substantially centered on the source pixel location. In an example embodiment, the source pixel may be rendered as a parallelogram, such as a square, rectangle, diamond, or the like, with a side length of n/4 display pixels, n/8 display pixels, n/16 display pixels, or the like. The rendered parallelogram may be substantially centered on the source pixel location.

A connector line may be defined between adjacent source pixels. Additionally or alternatively, connector lines may be defined between diagonal source pixels. In an example embodiment, the color value of the connector line may be interpolated between the source pixels to which each end of the connector line is connected. In some example embodiments, the interpolation of the color value of the respective connector lines is an average of the color value of the source pixels to which each end of the connector line is connected. In an example embodiment, the interpolation of the color value of the respective connector lines may be a linear interpolation between the color values of the source pixels to which each end of the connector line is connected. The linear interpolation may allow a smooth transition along the length of the connector line between the colors of the source pixels to which each end of the connector line is connected.

At still higher magnification, each of the source pixels may correspond to a display pixel array of N×N display pixels, with N>n. Each source pixel may be rendered as discussed at high magnification levels, e.g. rendered source pixels with connector lines between adjacent pixels. In an example embodiment, the source pixel may be rendered at the same display pixel value, e.g. the size (number of pixels) of the cluster of display pixels does not change with the change in magnification. In some example embodiments, the source pixel may be rendered at a lower display pixel value, e.g. the size (number of pixels) of the cluster of display pixels changes with the change between n and N. In an embodiment, in which the source pixel is rendered at a lower display pixel value at higher magnification, the change in display pixel value may be proportional to the change between n and N, semi proportional step changes of x pixels, or the like. In an example embodiment, the rending of source pixels may have a predetermined magnification or source pixel to display pixel ratio at which the display pixel value for a source pixel is no longer changed.

The display pixels which are not utilized for rendering the source pixels and/or the connector lines of the source pixel mesh image may be transparent, as no image data is rendered in this area.

As discussed above, FIG. 3 illustrates an example source image 300 at a low magnification 302 and a high magnification 304. The low magnification may be rendered with one or more source pixels corresponding to a display pixel as discussed above. In some embodiments the relatively low magnification 302 of the source image 300 may be rendered with a source image corresponding to more than one display pixel, e.g. 2-4 display pixels, using the replication techniques, discussed above.

The high magnification rendering 304 of the source image 300 may be a source pixel mesh image, as discussed above.

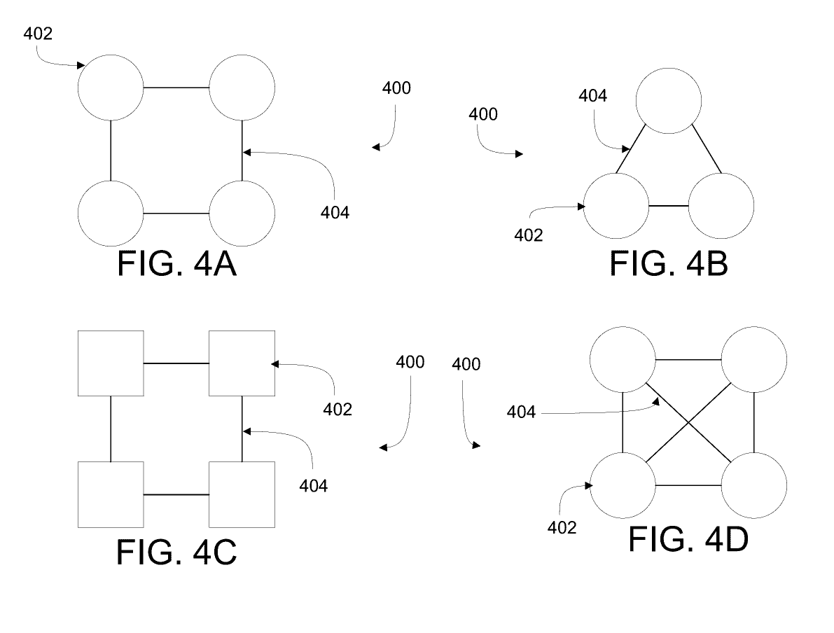

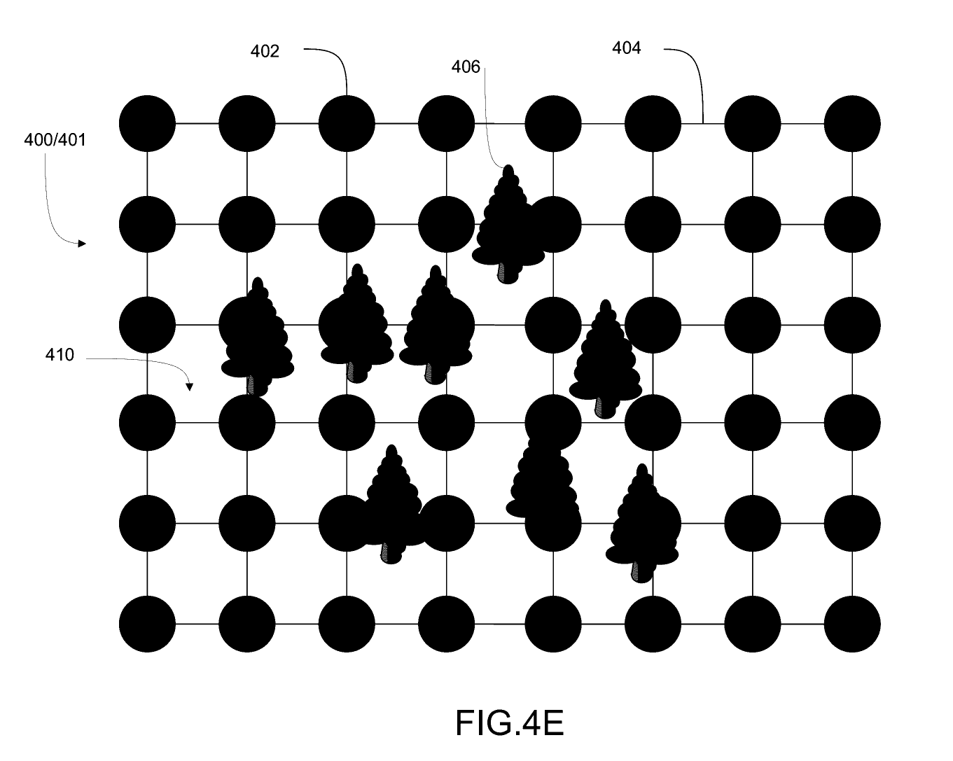

FIGS. 4A-4D illustrate example source pixel mesh image configurations in accordance with example embodiments. FIG. 4A illustrates an example embodiment in which the source image includes source pixels arranged in parallel lines, e.g. a square grid. The source pixel mesh image 400 may include a source pixel rendering 402. The source pixel rendering 402 may be a circle with a radius of x display pixels, e.g. n/2 display pixels, centered substantially on the source pixel location, wherein n is the number of pixels corresponding to the spatial extent represented by one source pixel. Connector lines 404 may be rendered between the adjacent source pixel renderings 402.

FIG. 4B illustrates an example embodiment in which the source image includes source pixels arranged in triangles. The source pixel rendering 402 may be centered substantially on the source pixel location and connector lines 404 may be rendered between each of the source pixel renderings.

FIG. 4C illustrates an example embodiment in which the source pixel renderings 402 of the source pixel mesh image 400 are parallelograms, in this example a square. The source pixel rendering may be substantially centered on the location of the source pixel. Connector lines 404 are rendered between each of the adjacent source pixel renderings 402.

FIG. 4D illustrates an example embodiment in which the source pixel renderings 402 of the source pixel mesh image 400 are circles substantially centered on the source pixel location. Connector lines 404 are rendered between the adjacent and diagonal source pixel renderings 402.

FIG. 4E illustrates a source pixel mesh image 400 of a source image overlaid on a second image 401. The source image and the second image 301 may include pixels which are associated with geolocations, anchors tags, or the like which identify one or more pixels which correspond to a specified point, location, object, or the like content in the image. In an example embodiment, the images may have global position coordinates associated with one or more pixels. In some example embodiments, anchor points may be tagged in the images, such as eyes, nose, chin, mouth, or the like of a face, or landmarks of a map or areal image. The second image or a portion of the second image may correspond to the source image based on image content or the geolocations, anchors tags, or the like.

The pixel aspect ratio of the source image and the second image for the same image content may not be the same, for example the source image may be satellite imagery of an geographic area and the second image may be a high resolution areal image. In an instance in which the corresponding geolocations or anchor tags have been aligned, the magnification and resolution of the source image and second image may be drastically different, for example the source image may be at a high magnification level utilizing a source pixel mesh image 400 while the second image 301 may be at a low or neutral magnification in which the source pixels are sufficient to render the display pixels without pixelization.

The source pixel mesh image 400 may include the source pixel renderings 402 and connector lines 404. The area 410 between the source pixel rendering 402 and the connector lines 404 may be transparent, e.g. no image data is rendered for the source image in this area. The second image 401 may be visible through the source pixel mesh image 400, allowing the content 406 of the second image to be rendered coherently with the source image.

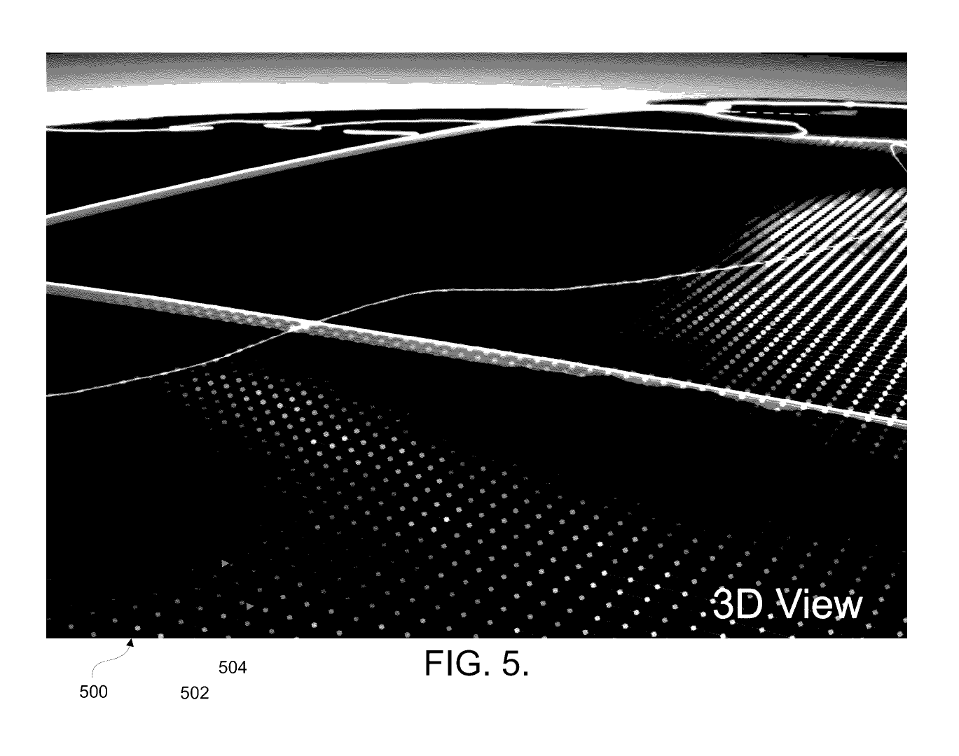

FIG. 5 illustrates an example embodiment in which a source pixel mesh image is rendered in an orthographic display, e.g. a three dimensional view. In some example embodiments the source image may include or be associated with a three dimensional model. The source pixel mesh image 500 may incorporate the three dimensional aspects, e.g. virtual elevation. The source pixel renderings 502 and the connector lines 504 may be rendered at elevations corresponding to the three dimensional model.

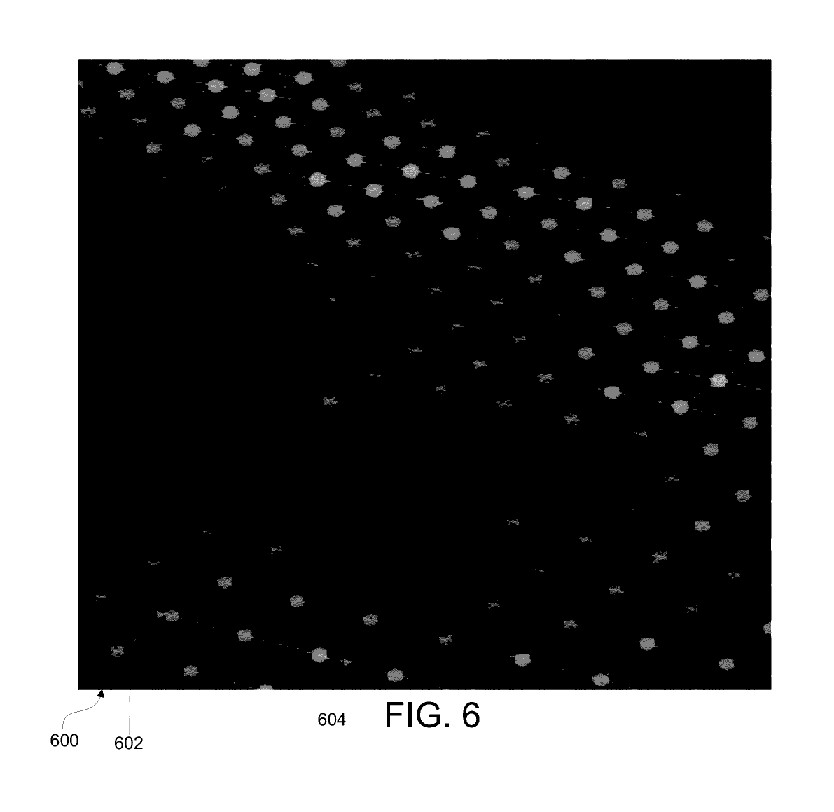

FIG. 6 illustrates a source pixel mesh image at a high level of magnification. The source pixel mesh image 600 includes source pixel renderings 602 and connector lines 604.

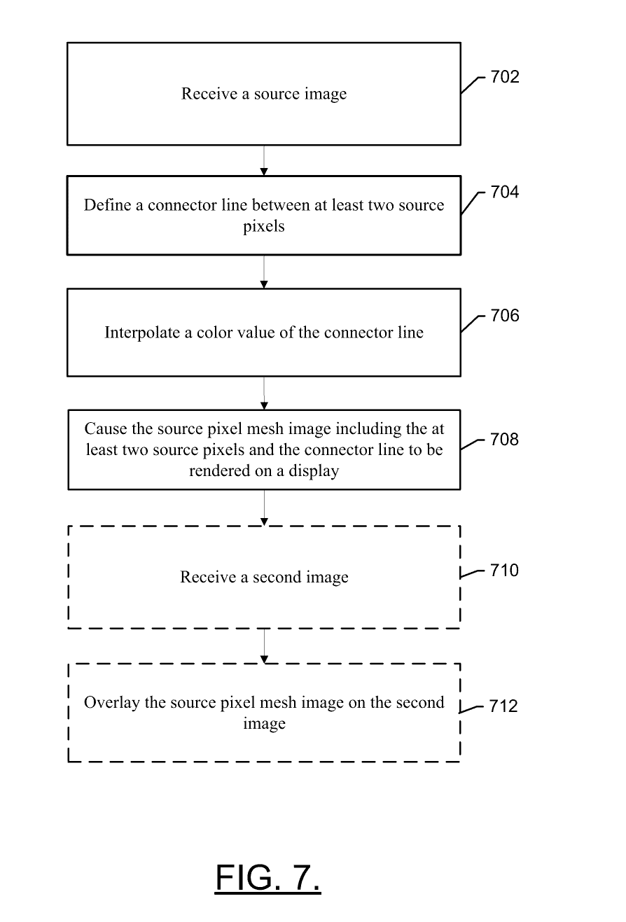

From a technical perspective, the rendering module 44 described above may be used to support some or all of the operations described above. As such, the platform described in FIG. 2 may be used to facilitate the implementation of several computer program and/or network communication based interactions. As an example, FIG. 7 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal (e.g. client 20, application server 40, and/or the like) and executed by a processor in the user terminal. As will be appreciated, any such computer program instructions may be loaded onto a computer or other programmable apparatus (e.g. hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention is shown in FIG. 7. The method may be employed for rendering a source pixel mesh image. The method may include, receiving a source image including a plurality of source pixels, at operation 702. The method may also include defining a connector line between at least two source pixel, at operation 704. At operation 706, the method may include interpolating a color value for the connector line. The method, at operation 708, may include causing the source pixel mesh image including the at least source pixel and the connector line to be rendered on a display.

In an example embodiment, the method may optionally include, as denoted by the dashed box, operation 710, receiving a second image corresponding the source image. The method may also optionally include overlaying the source pixel mesh image on the second image, at operation 712.

In an example embodiment, an apparatus for performing the method of FIG. 7 above may comprise a processor (e.g. the processor 52) or processing circuitry configured to perform some or each of the operations (702-712) described above. The processor may, for example, be configured to perform the operations (702-712) by performing hardware implemented logical functions, executing stored instructions, or executing algorithms for performing each of the operations.

In some embodiments, the processor or processing circuitry may be further configured for additional operations or optional modifications to operations 702-712. In this regard, for example the second image is visible through the source pixel mesh image when rendered. In an example embodiment of the method, the at least two source pixels include a first, second, and third source pixel and the connector line includes a first, second, and third connector line and the first, second, and third connector lines are disposed between the respective first, second, and third source pixel. In some example embodiments of the method, the at least two source pixels include a first, second, third, and fourth source pixel and the connector line includes a first, second, third, and fourth connector line and the first, second, third, and fourth connector lines are disposed between the adjacent source pixels of the first, second, third, and fourth source pixel. In some example embodiments of the method, the at least two source pixels include a first, second, third, and fourth source pixel and the connector line includes a first, second, third, and fourth connector line and the first, second, third, and fourth connector lines are disposed between diagonal source pixels of the first, second, third, and fourth source pixel. In an example embodiment of the method, the interpolation of the color includes averaging a color value of a first source pixel and a color value of a second source pixel of the at least two source pixels. In some example embodiments of the method, the interpolation of the color value includes a linear interpolation of a first color value of a first source pixel and a second color value of a second pixel of the at least two source pixels along a connector line length. In an example embodiment, the at least two source pixels of the source pixel mesh image are rendered at as circles or parallelograms including a plurality of display pixels. In some example embodiments of the method, an area between respective sets of the at least two source pixels and the connector lines of the source pixel mesh image is transparent.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. An apparatus comprising processing circuitry configured to execute instructions for rendering a source pixel mesh image, the instructions when executed causing performance of operations including:
receiving a source image comprising a plurality of source pixels;
defining a connector line between at least two source pixels;
interpolating a color value of the connector line; and
causing the source pixel mesh image comprising the at least two source pixels and the connector line to be rendered on a display.

2. The apparatus of claim 1, wherein the processing circuitry is further configured to execute instructions for:
receiving a second image corresponding to the source image; and
overlaying the source pixel mesh image on the second image.

3. The apparatus of claim 2, wherein the second image is visible through the source pixel mesh image when rendered.

4. The apparatus of claim 1 wherein the at least two source pixels comprise a first, second, and third source pixel and the connector line comprises a first, second, and third connector line and the first, second, and third connector lines are disposed between the respective first, second, and third source pixel.

5. The apparatus of claim 1, wherein the at least two source pixels comprise a first, second, third, and fourth source pixel and the connector line comprises a first, second, third, and fourth connector line and the first, second, third, and fourth connector lines are disposed between the adjacent source pixels of the first, second, third, and fourth source pixel.

6. The apparatus of claim 1, wherein the at least two source pixels comprise a first, second, third, and forth source pixel and the connector line comprises a first, second, third, and fourth connector line and the first, second, third, and fourth connector lines are disposed between diagonal source pixels of the first, second, third, and fourth source pixel.

7. The apparatus of claim 1, wherein the interpolation of the color comprises averaging a color value of a first source pixel and a color value of a second source pixel of the at least two source pixels.

8. The apparatus of claim 1, wherein the interpolation of the color value comprises a linear interpolation of a first color value of a first source pixel and a second color value of a second pixel of the at least two source pixels along a connector line length.

9. The apparatus of claim 1, wherein the at least two source pixels of the source pixel mesh image are rendered as circles or parallelograms comprising a plurality of display pixels.

10. The apparatus of claim 1, wherein an area between respective sets of the at least two source pixels and the connector lines of the source pixel mesh image is transparent.

11. A method for rendering a source pixel mesh image including:
receiving a source image comprising a plurality of source pixels;
defining a connector line between at least two source pixels;
interpolating a color value of the connector line; and
causing the source pixel mesh image comprising the at least two source pixels and the connector line to be rendered on a display.

12. The method of claim 11, wherein the processing circuitry is further configured to execute instructions for:
receiving a second image corresponding to the source image; and
overlaying the source pixel mesh image on the second image.

13. The method of claim 12, wherein the second image is visible through the source pixel mesh image when rendered.

14. The method of claim 11 wherein the at least two source pixels comprise a first, second, and third source pixel and the connector line comprises a first, second, and third connector line and the first, second, and third connector lines are disposed between the respective first, second, and third source pixel.

15. The method of claim 11, wherein the at least two source pixels comprise a first, second, third, and fourth source pixel and the connector line comprises a first, second, third, and fourth connector line and the first, second, third, and fourth connector lines are disposed between the adjacent source pixels of the first, second, third, and fourth source pixel.

16. The method of claim 11, wherein the at least two source pixels comprise a first, second, third, and fourth source pixel and the connector line comprises a first, second, third, and fourth connector line and the first, second, third, and fourth connector lines are disposed between diagonal source pixels of the first, second, third, and fourth source pixel.

17. The method of claim 11, wherein the interpolation of the color comprises averaging a color value of a first source pixel and a color value of a second source pixel of the at least two source pixels.

18. The method of claim 11, wherein the interpolation of the color value comprises a linear interpolation of a first color value of a first source pixel and a second color value of a second pixel of the at least two source pixels along a connector line length.

19. The method of claim 11, wherein the at least two source pixels of the source pixel mesh image are rendered as circles or parallelograms comprising a plurality of display pixels.

20. The method of claim 11, wherein an area between respective sets of the at least two source pixels and the connector lines of the source pixel mesh image is transparent.
